(19) United States
(12) Patent Application Publication
(10) Pub. No.: US 2016/0057185 A1
(43) Pub. Date: Feb. 25, 2016

(54) Streaming Service Provision Support in a P2P-CDN Streaming System

(71) Applicant: TELEFONAKTIEBOLAGET L M ERICSSON (PUBL), Stockholm (SE)

(72) Inventor: Shunliang Zhang, Beijing (CN)

(21) Appl. No.: 14/777,548

(22) PCT Filed: Mar. 21, 2013
(86) PCT No.: PCT/CN13/72984

§ 371 Date: Sep. 16, 2015

(51) Int. Cl. H04L 29/06; H04L 29/08

(52) U.S. Cl. CPC H04L 65/4069; H04L 65/608; H04L 67/104

(57) ABSTRACT

The invention refers to supporting a data stream provision towards a mobile user equipment—UE—(10a, 10b, 10c) within a communications network, the communications network comprising a mobile network (1), a data content network (2), wherein the data content network comprises a streaming control system (12d, 13a, 14a) for initiating the data streaming either from a content server (13b) having stored corresponding data stream content or from another UE-peer UE-(10a, 10b, 10c, 10d) having stored the data stream content, and wherein the mobile network (1) comprises a streaming support node (12c) for supporting the streaming control system, the streaming support node (12c) performing the steps of: acquiring information related to at least one of: a status and/or a capability of the mobile network (1) serving the UE (10a, 10b, 10c) and a status and/or a capability of the UE (10a, 10b, 10c) to be served, generating a streaming support information based on the acquired information, for supporting the streaming control system to decide whether to provide the streaming from the content server or from the peer UE (10a, 10b, 10c), and providing the streaming support information (S4) to a node of the streaming control system (12d, 13a, 14a). The invention further refers to a streaming support node (12c), a streaming control system (13a, 14a) and to computer programs.

### TECHNICAL FIELD

The present invention relates data streaming, and especially to data streaming with respect o a mobile radio terminal, and further especially involving a content delivery network—CDN—and a peer-to-peer network.

### BACKGROUND

Recently, due to the quick growth of smart phone penetration, data traffic on mobile network is experiencing significant growth. At the same time, more affordable service and application are expected by end users. Therefore, many operators are facing the challenge to offload their overloaded networks and reduce the transport and peering cost. Facing this situation, so-called Content Delivery Networks have been proposed attracting more and more attention. CDN is able to provide an excellent quality to end-users when the data load is within the provisioning limits. CDN typically has to provide servers and bandwidth in advance using estimates of the expected data load and are thus inherently constrained by the specifics of their operating regime. While, in case the number of users is huge, CDN may have scalability problem because large number of CDN infrastructure (CDN DN/CDN service node) needs to be deployed.

Also recently, so-called peer-to-peer—P2P streaming services, e.g. video services, have evolved. P2P allows for a sharing of computer resources and services by direct exchange of information among peers. In other words, in a P2P communication system, the clients (peer terminals) perform also server functions. By leveraging resources of the participating peers, scalability issues of streaming services, may be solved.

To enjoy advantages of both P2P and CDN and/or avoid the disadvantages of each single approach, a so-called hybrid P2P-CDN system has been proposed as a promising way forward. Such a system is e.g. disclosed in U.S. Pat. No. 8,332,484 wherein one or more peers are used as edge servers of a CDN network, so that CDN customer content may be delivered by the CDN network or by a P2P network depending on hybrid P2P-CDN system information; e.g. serving the UE with P2P streaming mode or CDN streaming mode in dependency of a load status of CDN nodes.

However, P2P streaming applications may bring some serious problems to the mobile network or the UE. For example, a constantly large number of small P2P signaling packets associated to media chunk packets may burden the radio network, especially when the radio network is serving many P2P users at the same time. Further, a continuous upload transmission associated to P2P streaming may drain out UE battery soon.

### SUMMARY

It is an object of the present invention to provide a CDN-P2P system taking into account mobile network and/or mobile user characteristics.

This object is achieved by the independent claims. Advantageous embodiments are described in the dependent claims.

According to embodiments, a data streaming service is provided towards a mobile user equipment—UE—within a communications network, the communications network comprising a mobile network and a data content network, also being referred to as (hybrid) content data and peer-to-peer network (CDN-P2P) network.

The data content network may comprise a streaming control system for controlling, supervising or initiating a data streaming either from a content server having stored a suitable data content, also being referred to as content server streaming, or a data streaming from another UE—peer UE—having stored the same data content.

A streaming support node (located or associated to the mobile network) for supporting the streaming control system performs the following steps:
acquiring information related to at least one of: a status and/or a capability of the mobile network serving the UE and a status and/or a capability of the UE to be served and/or policy of the mobile network operator on streaming delivery approach,
generating a streaming support information based on the acquired information, for supporting the streaming control system to decide whether to provide the streaming from the content server or from the peer UE, and
providing the streaming support information to a node, e.g. to one or both of a CDN control node or a P2P tracker node, of the streaming control system.

This allows to serve a UE not (only) based on CDN-P2P network status, but to take an activity or actual load and/or capabilities in the radio access network into account.

The streaming support information may be provided in response to a reception of a request to provide the streaming support to the streaming control system.

The streaming support information may additionally comprise streaming policy information.

The streaming support information may be updated in response to detecting a change of a status and/or a capability of at least one of the UE and the mobile network.

Acquiring information related to the mobile network may comprise acquiring information indicative of at least one of:
a radio cell load status in downlink—DL—direction,
a radio cell load status in uplink—UL—direction,
an available DL guaranteed bit rate,
an available UL guaranteed bit rate, and
a none-guaranteed bit rate derived from remaining air interface capacity.

Acquiring information related to the UE may comprise acquiring information indicative of at least one of:
a preference for streaming reception from the content server (13b) or from the peer UE,
a status and/or a capability of the UE power supply, e.g. information indicative of a stored energy and/or an energy consumption,
a location UE with respect to base stations of a radio access network,
radio access technology capabilities, and
radio access technology usage.

According to embodiments, upon a reception of the streaming support information, the streaming control system decides, based on the streaming support information, which of the streaming modes comprising the content server streaming mode and the peer-to-peer streaming mode is to be performed. The streaming control system may decides, whether to in response to an actually received streaming support information a streaming mode shall be switched from server streaming mode to peer-to-peer streaming mode and vice versa, and transmits an indication information to the UE comprising an information indicative of an instruction to switch the streaming mode.

According to embodiments the information related to the UE is indicative of a speed of the UE, and wherein this information used such that it is determined if the UE moves at a speed above a certain speed (e.g. by detection a certain number of cell handovers related to the UE), and wherein in this case content server streaming is preferred over peer-to-peer streaming, e.g. by prohibiting peer to peer streaming.

In an embodiment, the method described above is realized within a support node associated to the mobile network, preferably a so-called PCRF node according to 3GPP. The support node may comprise a first interface (Gx) adapted for communicating with a gateway node of the mobile network to receive information related to at least one of: a status and/or a capability of the mobile network serving the UE and a status and/or a capability of the UE to be served, a processor adapted for generating a streaming support information based on the acquired information for supporting the streaming control system to decide whether to provide the streaming from the content server or from the peer UE, and a second interface (Rx) adapted for communicating with a data content network to providing the streaming support information to the application server, e.g. the streaming control system

The present invention also concerns computer programs comprising portions of software codes in order to implement the method as described above when operated by a respective processing unit of a server or user equipment discussed above. The computer program can be stored on a computer readable medium. The computer-readable medium can be a permanent or rewritable memory e.g. within service node or the information server or located externally. The respective computer program can be also transferred to the servers for example via a cable or a wireless link as a sequence of signals.

In the following, detailed embodiments of the present invention shall be described in order to give the skilled person a full and complete understanding. However, these embodiments are illustrative and not intended to be limiting.

### BRIEF DESCRIPTION OF THE FIGURES

FIG. 1a shows a block diagram illustrating first exemplary communications network for performing hybrid P2P-CDN streaming services to mobile user devices,

FIG. 1b shows a diagram illustrating a second exemplary communications network for performing hybrid P2P-CDN streaming services to mobile user devices,

FIG. 2a shows an exemplary sequence of method steps performed by a streaming support node

FIG. 2b shows a principle block diagram of the streaming support node,

FIG. 3a-d show four exemplary sequence diagrams illustrating a streaming node selection and/or switching.

### DETAILED DESCRIPTION

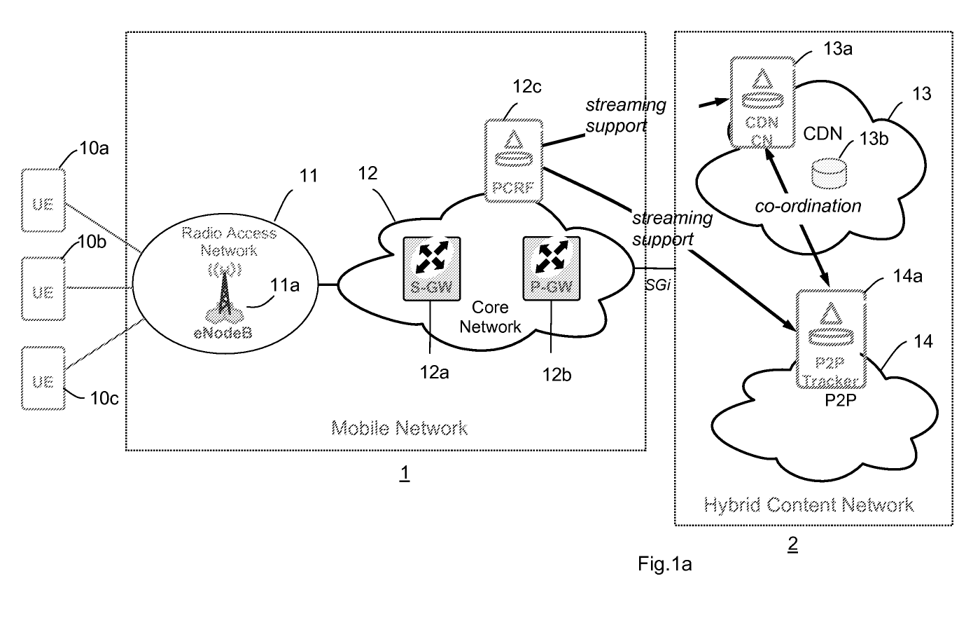

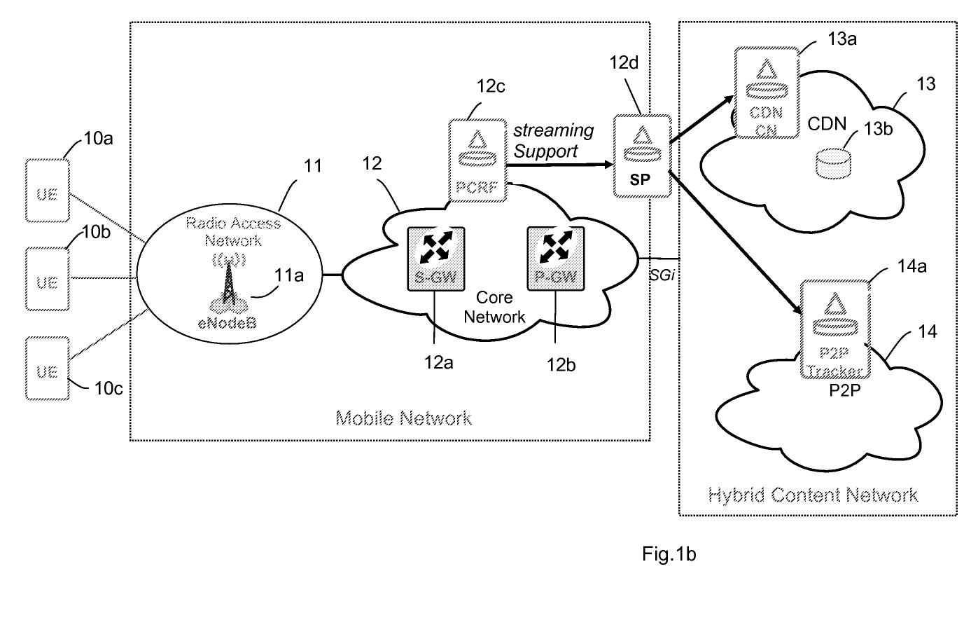

FIG. 1a shows a principle block diagram with a communications network and a plurality of mobile terminals or user equipments 10a-10c being connected to the communications network. The communications network comprises a mobile network 1 and packet data network 2.

The user equipments (UE) 10a -10c are radio terminals being capable of connecting to the radio access network 11, and further being capable of data streaming processing by means of peer-to-peer data streaming and CDN streaming.

The mobile network 1 comprises a radio access network—RAN—domain 11 and a core network domain 12. The RAN 11 by way of example may comprise different access technologies like GSM, UMTS Terrestrial Radio Access Network—UTRAN—and evolved UMTS Terrestrial Radio Access Network (eUTRAN). Exemplarily, the access domain in FIG. 1a shows an LTE base station 11a that is responsible for connecting the UEs served by the eUTRAN to the core network 12, also being referred to as eNodeB 11a.

Further exemplarily, the core network 12 is a so-called Evolved Packet Core—EPC—network according to 3GPP. FIG. 1a exemplarily depicts a serving gateway S-GW 12a, and a Packet Data Network Gateway P-GW 12b as nodes of the core network 12.

The S-GW 12a is a gateway which terminates the mobile network towards the eUTRAN 11. Amongst other functions, this gateway serves as a local mobility anchor (e.g. with respect to eUTRAN's eNodeB handover).

The P-GW 12b terminates the mobile network by means of the so-called the SGi interface towards the packet data network domain and is thus responsible for an interworking between a mobile packet data network and the packet data network.

The core network 12 may further comprise a mobility management entity—MME—(not shown) for managing the mobility of the UEs allowing to access network services anywhere, as well as to continue their ongoing communication and to access network services anywhere. It is further involved in the bearer activation/deactivation process and is also e.g. responsible for choosing the S-GW for the UE.

The core network 12 further comprises a policy server 12c that might comprise a so-called Policy and Charging Rules Function (PCRF) according to 3GPP. This function may determine policy rules with respect to the mobile network and/or the content network in real-time. Further, the PCRF may be able to access data bases, e.g. subscriber databases and specialized functions, such as charging. According to embodiments of the invention, the policy server 12c is enhanced with mobile streaming functionality—MSF to acquire information related to the mobile network serving the UE, UE information, and/or mobile operator policy information, to generate streaming support information by processing the collected information and to provide the streaming support information to the packet data network 2. Particularly, the streaming support information provides support information enabling the hybrid content network to deciding about the streaming mode to be used for serving the UE. Alternatively to associating the MSF with the policy server, the MSF may be realized as stand-alone server.

The packet data network comprises a content delivery network—CDN—13 and a peer-to-peer—P2P—network 14 and means for controlling a data provision to the UEs either by means of data streaming from the network or by streaming from UE peers, and is thus also being referred to as hybrid content network or hybrid CDN-P2P network.

The CDN 13 may comprise a plurality of CDN distribution nodes that may be distributed at a plurality of different geographical locations and may be physically associated to different parts of the network. FIG. 1 a shows an exemplary CDN distribution node—CDN DN—13b being part of, or being associated to the CDN 13.

The CDN 13 further comprises a CDN server or CDN CN (control node) 13a comprising global load balancing functionality for balancing CDN resources (e.g. balances the load with respect to different CDN DNs) by selecting CDN DN or supporting a CDN DN selection with respect to a request from the UE.

The P2P network 14 comprises a plurality of peer nodes a P2P tracker 14a. As discussed above, it is a characteristic of P2P systems that the network terminals (peers) also perform server or router functions. Thus, one or a plurality of the UEs 10a -10c may form (virtual) part of the P2P network. The P2P tracker 14a assists to the peers for performing streaming services to each other.

Both the CDN CN 13b and the P2P tracker 14a may be regarded as to forming the control instance or system of the hybrid CDN-P2P network. Both control nodes may receive the streaming support information from the policy server 12c and coordinate in order to perform the streaming service with respect to the UEs 10a-10c

In the following, the information collected by the policy server/MSF may comprise the following information:
Information with respect to status or capabilities of the mobile network, in the following also being referred to as mobile network information; e.g. radio base station/cell load status info (downlink—DL—and/or uplink—UL, C-plane and/or U-plane respectively), information indicative of an available UL and/or DL guaranteed bit rate, and/or indicative of a none guaranteed bit rate derived from remaining air interface capacity,
information with respect to status or capabilities of the UE, in the following also being referred to as UE information; e.g. user's preference on streaming delivery (P2P or CDN), UE location, UE battery capacity and/or load status, available access technologies, access technology actually used by the UE (Mobile access technology or fixed access technology). In the case of mobile radio access, information indicative of radio UL and DL quality of the UE (to avoid huge signaling overhead, the link quality could be averaged info over certain time period), and UE mobility information, and
information with respect to mobile operators' strategy and/or policy on streaming delivery (P2P or CDN) over the mobile network, in the following also being referred to as (streaming) policy information, e.g. information per subscriber level or per RAN or PLMN level.

The MSF processes the collected information to generate the streaming support information for supporting the hybrid CDN-P2P network. According to embodiments of the invention, the P2P tracker 14a and the CDN CN 13a coordinate the streaming service provision based on streaming support information received from the MSF/policy server 12c to selectively take a UE to a CDN or P2P streaming mode upon receiving a streaming service request, or to initiate a switching between CDN streaming mode and P2P streaming mode in a flexible and dynamic way based on the streaming support information.

FIG. 1b shows an alternative embodiment with respect to FIG. 1a, introducing an additional element or node being referred to as service platform 12d exemplarily being depicted as part of the mobile network 12. The service platform 12d retrieves the mobile network information, the UE information and/or the streaming policy information by communication with the policy server 12c and or with appropriate nodes of the mobile network and generates the streaming support information to the hybrid CDN-P2P network control system. Further, not being discussed in further detail, the service platform may enable third party applications by supporting with information acquired from the mobile network (PCRF). A new interface may be provided between the policy node (PCRF) 12c and the service platform 12d or the existing Rx interface may be enhanced to exchange the streaming support information and optionally requirements from the third party applications running over the platform to coordinate the requirement and capability among more network operators and third party applications with respect to hybrid P2P-CDN streaming services.

According to both embodiments described under FIG. 1a and FIG. 1b, a streaming mode decision is performed based on the support information (provided from the policy server 12c and/or the service platform 12d). After having performed the decision, the hybrid P2P-CDN control system may execute the decision (selecting a CDN streaming mode or P2P streaming mode with respect to a new streaming service request, or switching between these streaming modes with respect to an ongoing streaming session) by an interworking or coordination between the CDN CN and the P2P tracker. In case a streaming mode change from P2P streaming mode to CDN streaming mode or vice versa shall be performed for an ongoing session, the hybrid P2P-CDN control system or the service platform may initiate a streaming mode switching based on updated streaming support information. Additionally to the support information, further information, e.g. CDN subscription, CDN load status etc.) may be taken into account for the streaming mode decision.

The following examples may illustrate principles to select a streaming mode to serve a UE adaptively:

If both P2P and CDN streaming mode are permitted to serve the UE as a result of an evaluation of policy information and/or UE information, while the mobile network information (load status) indicates that P2P is not preferred to serve the UE in a specific RAN area, the hybrid P2P-CDN system may select the CDN mode to be used to serve a new UE request. Upon a change of network status information, the hybrid P2P-CDN system may reselect the mode applied to the UE and initiate a mode switching from CDN mode to P2P mode for the ongoing streaming session.

If both P2P and CDN streaming mode are permitted to serve the UE as a result of an evaluation of UE information and mobile network information, while the policy information indicates that CDN streaming mode is preferred (at certain time or certain area) for the specific UE, the hybrid P2P CDN control system may select the CDN streaming mode to be used to serve a new UE with a requested streaming service or may initiate a mode switching from P2P streaming to CDN streaming with respect to the UE.

In case both P2P and CDN streaming mode are permitted to serve a UE as a result of an evaluation of policy information and mobile network information, while the UE information indicates that P2P streaming is preferred (e.g. at certain circumstances like fixed access), the hybrid P2P CDN system may select the P2P streaming mode to serve the UE streaming request. Upon a change of the UE information (e.g. a change of users preference due to the change of access technology), the hybrid P2P-CDN system may reselect the mode applied to the UE and initiate a switching process accordingly.

To indicate the UE preference (e.g. user's preference) on streaming content delivery mode, a streaming client function or application—APP—in the UE may generate appropriate messages to be sent to the P2P-CDN control system. Thereto, a new message format or an enriched P2P message or DNS message format may be defined comprising an information element for conveying the UE streaming preference. The client function may fill the information element according to the UE preference to be sent to the P2P-CDN control system at initial service request and/or upon detection of a change of preference (e.g. in cases of conditional preference based on certain UE status).

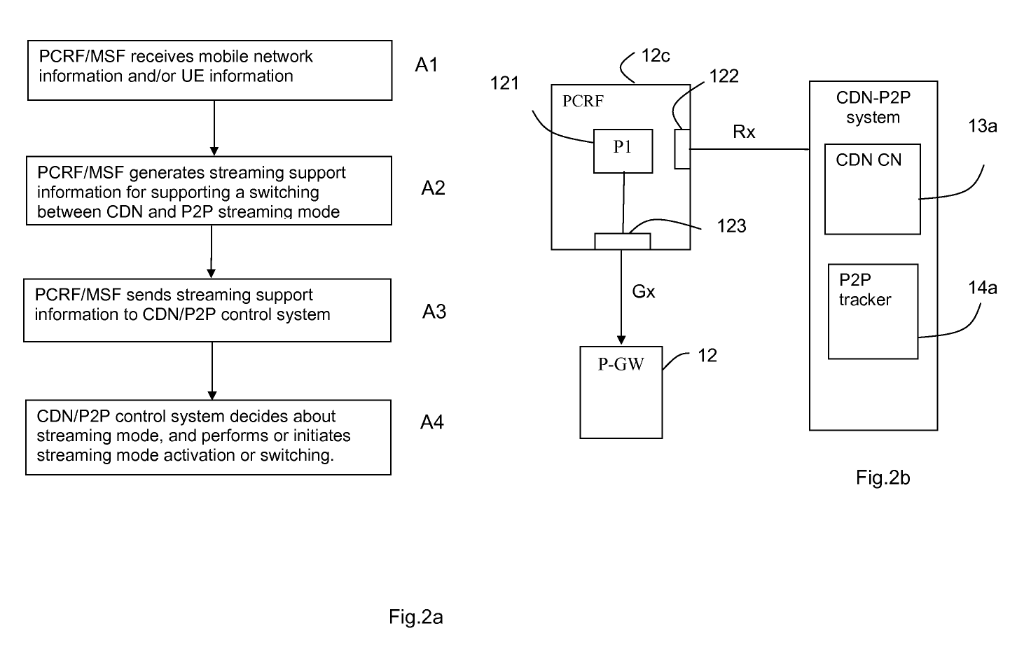

FIG. 2a shows an exemplary principle sequence of steps to perform a streaming support according to previous figures.

In a first step A1, the MSF associated to the policy server (PCRF/MSF) 12c receives mobile network information and/or UE information as discussed above. Additionally, the MSF my receive operator policy information.

In a second step A2, the PCRF/MSF generates streaming support information by processing the received information.

In a third step A3, the PCRF/MSF sends the streaming support information to the hybrid P2P-CDN control system comprising a CDN control node (CN) 13a and a P2P tracker 14a.

In a fourth step A4, hybrid P2P-CDN control system decides about a streaming mode with respect to a streaming service response of the UE and performs/initiates a streaming mode activation or switching.

FIG. 2b shows a simplified block diagram of PCRF 12c being connected to P-GW 12 over a so-called Gx interface and to the CDN-P2P control system over a so-called Rx interface, wherein Rx and Gx interfaces are specified in general by 3GPP. PCRF 12c may comprise a processor 121, an Rx interface function circuit 122 terminating the Rx interface, e.g. receiving and sending information to an application function, and a Gx interface function circuit 123 terminating the Gx interface, e.g. receiving and sending information to the application function. The processor 121 is connected to both interface function circuits 122 and 123 to receiving the mobile network information, UE information and/or operator policy information over Gx interface 123 and P-GW 12, to generate the streaming support information by processing the received information, and to send the streaming support information over the Rx interface 122 towards the CDN-P2P control system (i.e. towards CDN CN 13a and/or P2P tracker 14a).

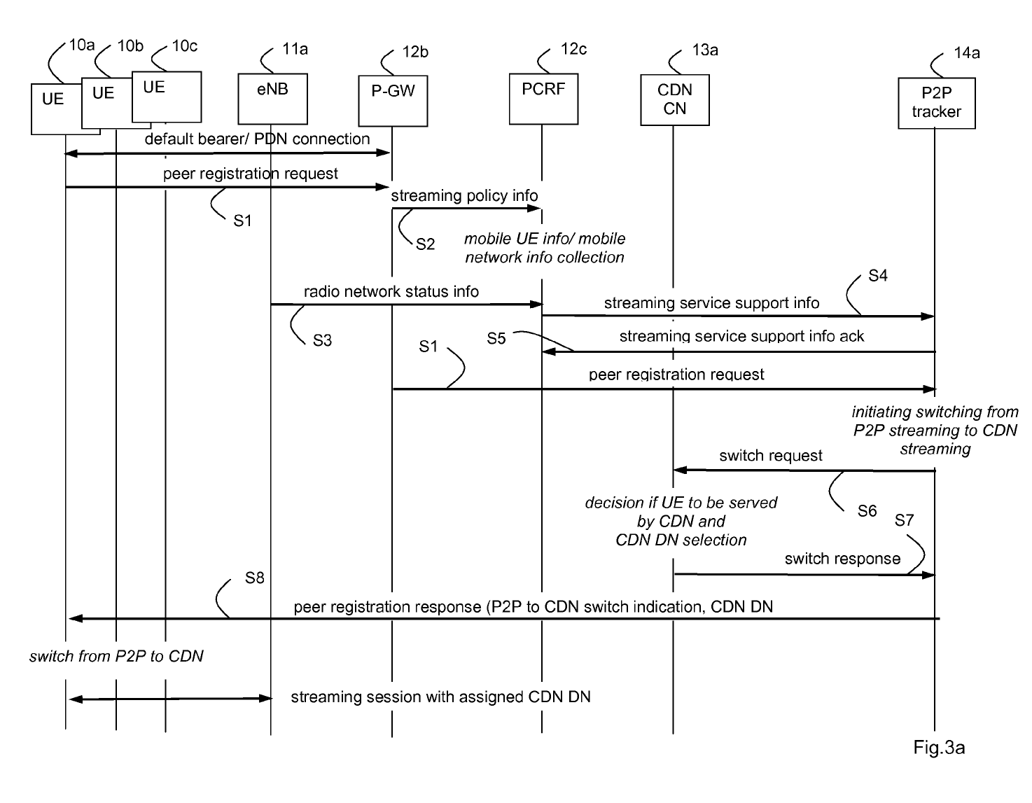

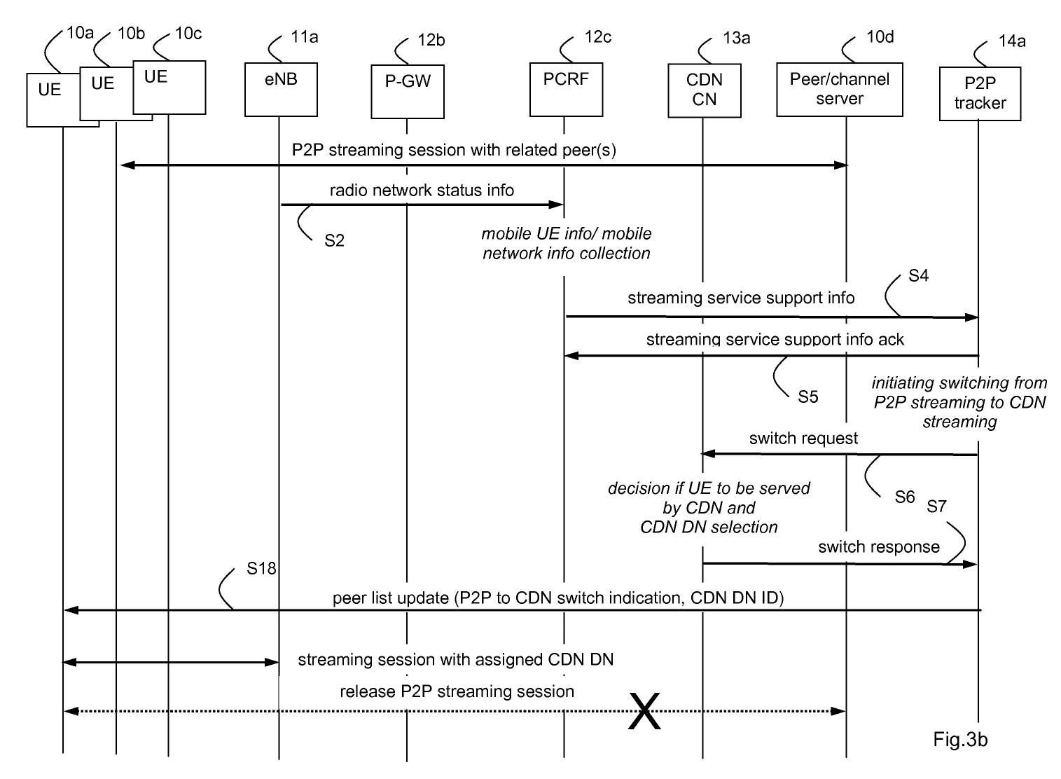

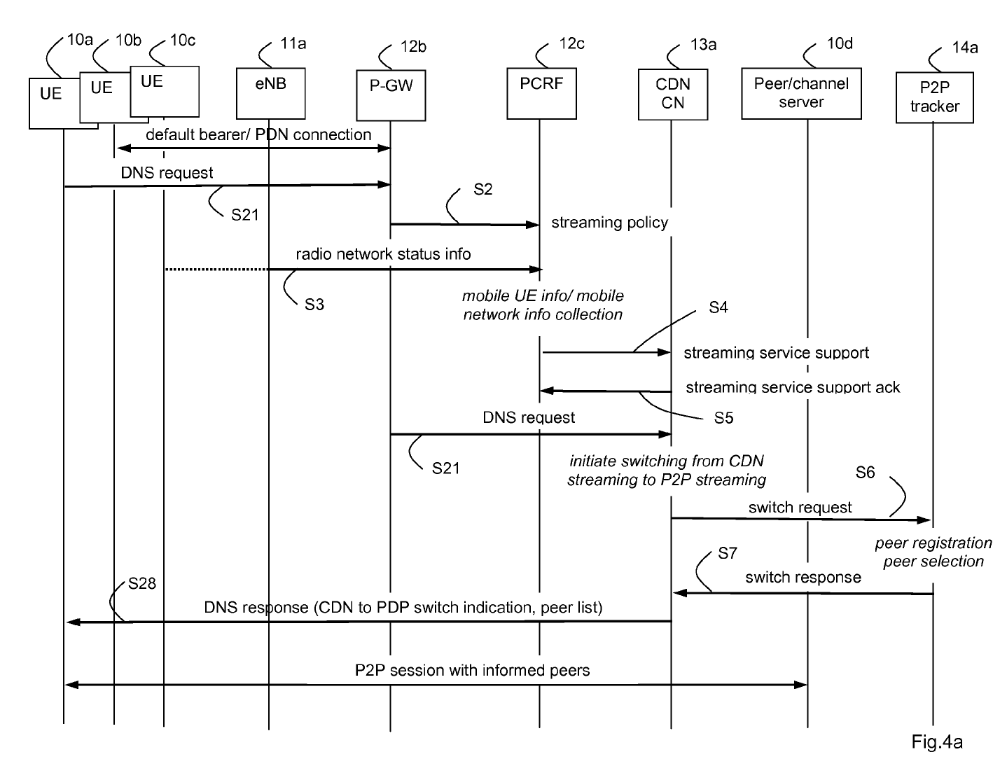

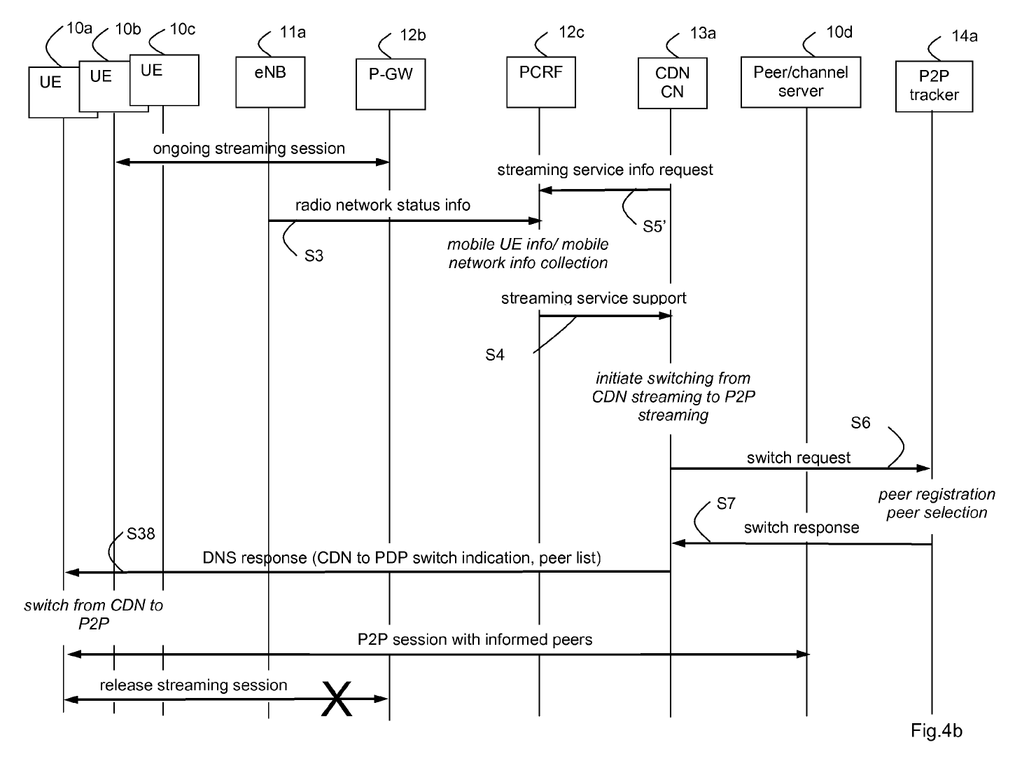

In the following, different exemplary scenarios for performing a decision about whether to provide CDN streaming mode or P2P streaming mode in response to a user streaming service request, and/or to decide about a streaming mode switching are described in more details being illustrated by FIGS. 3a, 3b, 4a and 4b. Essentially similar nodes are involved as discussed in detail. Similar messages or essentially similar messages shown in the following FIGS. 3a, 3b, 4a and 4b are provided with similar reference signs.

By way of example, FIG. 3a and FIG. 3b illustrate a P2P to CDN switching wherein FIG. 3a refers to a new streaming session, and FIG. 3b refers to an ongoing streaming session.

Thereto, FIG. 3a shows an exemplary plurality of user equipments 10a, 10b, and 10c and a plurality of network nodes shown in FIG. 1a and FIG. 1b, notably eNB 11a, P-GW 12b, policy server or PCRF 12c, CDN CN 13a and P2P tracker 14a, exchanging a plurality messages to perform a streaming service provision in response to a (P2P) streaming service request:

By way of example, a first mobile device (first mobile peer)—UE—10a of the plurality of mobile devices 10a-c transmits, e.g. through a default bearer or an existing PDN connection, a peer registration request S1 towards a P2P tracker 14a to join a P2P group for getting a certain streaming service. UE 10a may further send (e.g. by enhancing the P2P registration request) mobile UE related info e.g. to indicate the user's preference on a streaming delivery, e.g. an information of whether P2P or CDN streaming is preferred or requested.

The packet gateway—P-GW—12b detects, e.g. by means of a so-called deep packet inspection—DPI—function of the peer registration request S1 sent from the mobile by UE 10a towards the P2P tracker. In response to the detection, the P-GW 12b may initiate a streaming service support information process. During this process, the P-GW 12b sends a streaming policy information message S2 to the streaming support function, in the following also being referred to as MSF that by way of example is hosted by the PCRF 12c. The message S2 may further comprise UE information e.g. comprising the user's preference on streaming delivery, UE location, UE status and/or capability (e.g. comprising battery load/status access technology used by the UE (e.g. mobile radio access technology or fixed access technology), wherein in case of using a mobile radio access, radio link quality info (stability, average strength, etc) of the UE, and/or UE mobility information may be reported as well.

Some UE information may be regarded as non network related information, such as user preference, battery status. Such information may be conveyed by the UE e.g. by extending application layer messages. Other UE information may be regarded as related to the network, such as location information, access network technology used, UE mobility information, and link quality information. Such may be detected by the network, e.g. by the eNodeB 11a, the S-GW 12a or the P-GW 12b.

If the UE 12a is attached or connected to a radio access network, e.g. GSM, UTRAN or eUTRAN, the MSF may initiate a process to receiving a (e.g. in response to a corresponding request not shown in FIG. 3a) access network related information from the access network (e.g. from the base station—eNB—11a). Thereto, the eNB 11a may send a radio network status information message S3 comprising radio base station/cell load information (DL/UL C-plane and U-plane), backhaul link load information, base station scheduler load information, and/or available bit rate information derived from remaining air interface capacity and may be transmitted. The radio network status info message S3 may be conveyed via the P-GW over the Gx interface.

Based on the information gathered in the previous steps (mobile network information, mobile UE information) and/or on mobile operator policy and the streaming content requested by the UE, the MSF provides a streaming service support information message S4 comprising related information to the hybrid P2P-CDN control system (e.g. to the P2P tracker 14a).

The operator policy may be based on static user information (type, subscription). As an example, the policy may be to prohibit P2P in certain time frames and/or certain areas for all or certain users. Alternatively the operator policy may be generated dynamically based on feedback of other users (e.g. in order to determine overload areas/time frames) and/or dynamic subscription information.

The UE mobility information may comprise an indication of the UE speed that may be determined by the eNodeB or by information conveyed by the eNodeB, such as a cell handover—HO—record indicative of a frequency or a number over a time of cell handovers, The speed information may used in such a way that if the UE moves at high speed, e.g. if a number of handover occurring in a certain time is above a defined threshold, it is preferred to not instruct the UE to switch to P2P streaming mode, as the high speed may cause an unstable link quality. Moving at the high speed may further indicate that the UE is not able to recharge the battery while UL transmission in a peer mode consumes significant power.

The P2P tracker 14a may confirm reception of the message from the PCRF by a streaming service support information acknowledge—ACK—message S5.

Upon the reception of the peer registration request S1 received from UE 10a, the P2P tracker 14a performs a decision about which mode shall be used to deliver the streaming content to the user. This decision is performed based on information of the streaming service support information message S4 (and on P2P-CDN system internal information).

The P2P tracker 14a may determine based on the received information, which streaming mode is preferred. In case that P2P streaming mode is not preferred, the P2P tracker may communicate with the CDN CN to determine, if the UE 10a can be served with CDN mode.

Thereto, The P2P 14a tracker sends a switch request S6 to the CDN control node 13a to request the CDN system to serve the UE 10a with the required streaming service. The message may include a UE identity (UE ID), URL or streaming content ID/description, and UE information.

The CDN control node 13a decides if the user can be accepted based on the received information from the P2P tracker 14a. In case of acceptance, the CDN CN may select one CDN DN/Cache node of a plurality of available nodes to serve the UE 10a.

The CDN CN 13a replies the P2P tracker 14a with a switch response S7 indicating if the user can be served by CDN mode. The switch response S7 may indicate the switch result, UE identity—ID—, and the ID/IP address of the selected CDN DN/Cache node.

The P2P tracker 14a sends a peer registration reply S8 to the UE 10a. In case UE 10a is requested to switch to CDN mode, the reply S8 may comprise a switch indication to request the UE 10a to switch to CDN mode for the requested streaming service, and an address (IP address) of the CDN DN/cache node.

UE 10a switches to CDN mode and directs the streaming service request directly to the indicated CDN DN/cache mode.

FIG. 3b shows a further sequence of messages for switching from P2P streaming mode to CDN streaming mode for an ongoing session. By way of example, essentially the same terminals and nodes with respect to FIG. 3a are comprised, but additionally, a channel server node or further peer 10d is involved:

The MSF may repetitively receive actual network status information messages S3, e.g. by requesting this information from an appropriate node or by receiving the radio access network info upon a radio access status change.

Upon a change of at least one of mobile network info, mobile UE info and mobile operator policy (preconfigured locally or dynamically generated), streaming content requested by the UE, and mobile network information, the MSF may send corresponding updated streaming service support messages S4 to the P2P tracker 14a.

As discussed previously, the P2P tracker 14a my respond to the MSF with streaming service support information acknowledge—ACK—message S5.

Upon the reception of the updated information from the MSF, the P2P tracker may reconsider the streaming mode to be used for delivering the streaming content (of the ongoing session) to the UE 10a. Coming to a decision that the UE 10a should not be served with P2P mode any more, the P2P tracker may initiate a process with the CDN CN 13a to initiate a CDN streaming service with respect to the UE 10a.

Thereto, the P2P tracker sends switch request message S6 to the CDN CN 13a to ask the CDN system to serve the UE 10a with the requested streaming service. The message may include at least one of UE ID, URL or streaming content ID/description, mobile UE info.

The CDN CN 13a decides if the user can be accepted based on the information received from the P2P tracker 14a. In the case of acceptable, the CDN CN selects a CDN DN/Cache node to serve the UE.

The CDN control system responds to the tracker by sending switch response message S7 indicative of whether the user can be served by CDN mode or not. The message may indicate the switch result, UE ID, and the ID/IP address of the selected CDN DN/Cache node.

The P2P tracker 14a sends a peer list update message S18 (instead of peer registration request S8 of FIG. 3a) to the UE 10a to inform the streaming mode change from P2P to CDN for the ongoing streaming service. The peer list update message S18, similar to peer registration request S8, may comprise a switch indication to request or instruct the UE 10a to switch to CDN mode for the requested streaming service, and an address (IP address) of the CDN DN/cache node.

UE 10a switches to CDN mode and directs the streaming service request directly to the indicated CDN DN/cache mode.

FIG. 4a shows a further sequence of messages for switching from CDN streaming mode to P2P streaming mode for a new session. Again by way of example, essentially the same terminals and nodes with respect to FIG. 3b are comprised:

UE 10a of the plurality of mobile devices 10a-c transmits, e.g. through a default bearer or an existing PDN connection, a DNS request message S21 towards a DNS server to find a streaming server which can provide a specific streaming service. UE 10a may further send (e.g. by enhancing the P2P registration request) mobile UE related info e.g. to indicate the user's preference on a streaming delivery, e.g. an information of whether P2P or CDN streaming is preferred or requested.

Similar to the description under FIG. 3a, the gateway—P-GW—12b may detect, e.g. by means of the DPI function of the DNS request that a mobile streaming service is requested by the UE. In response to the detection, the P-GW 12b may initiate a streaming service support information process. During this process, the P-GW 12b sends streaming policy information message S2 to the MSF as discussed previously under FIG. 3a and FIG. 3b.

As discussed above, if the UE 12a is attached or connected to a radio access network, e.g. GSM, UTRAN or eUTRAN, the MSF may initiate a process to receiving access network related information from the access network. Thereto, the eNB 11a may send a radio network status information message S3 comprising radio base station/cell load information, backhaul link load information, base station scheduler load information, and/or available bit rate information derived from remaining air interface capacity and may be transmitted. The message S3 may be enhanced by UE information informing about status and preferences of the UE 10a.

Based on the information gathered in the previous steps (mobile network information, mobile UE information and/or on mobile operators policy and the streaming content request, the MSF provides a streaming service support information message S4 comprising related information to the hybrid P2P-CDN control system (e.g. to the CDN CN 13a).

The hybrid P2P-CDN control system (CDN CN 13a) may confirm reception of the message from the PCRF by a streaming service support information acknowledge—ACK—message S5.

Upon the reception of the DNS request message S21 from the UE, the hybrid P2P-CDN control system (CDN CN) performs a decision which streaming mode is to be used to deliver the streaming content to UE 10a based on the streaming support information S4.

The CDN CN 13a may determine based on the received information, which streaming mode is preferred. In case that CDN streaming mode is not preferred, the CDN CN may communicate with the P2P tracker to determine, if the UE 10a can be served with P2P mode.

Thereto, CDN control node 13a sends switch request S6 to the P2P tracker 14a to request the P2P system to serve the UE 10a with the required streaming service. The message may include a UE identity (UE ID), URL or streaming content ID/description, and UE information.

Based on the information included in switch request S6, the P2P tracker determines a peer list of peers that can be contacted by the UE 10a and replies to the CDN CN with switch response S7 comprising an indication to request the UE switch to P2P mode for the requested streaming service, and a peer list of peers to be contacted by the UE.

The CDN CN 13a sends a DNS response S28 comprise the switch indication to request the UE 10a to switch to P2P mode for the requested streaming service, and the peer list.

Upon reception of the DNS response S28, UE 10a switches to P2P mode and initiates P2P sessions with a peer from the provided peer list to receive the streaming service.

FIG. 4b shows a further sequence of messages for switching from CDN streaming mode to P2P streaming mode for an ongoing streaming session. Again by way of example, essentially the same terminals and nodes with respect to previous figures are involved:

The MSF may repetitively receive actual network status information messages S3, e.g. by requesting this information from an appropriate node or by receiving the radio access network info upon a radio access status change.

Upon a change of at least one of mobile network info, mobile UE info and mobile operator policy, streaming content requested by the UE, and mobile network information, the MSF updates related information may send corresponding updated streaming service support messages S4 to the CDN CN 13a.

According to the example shown here, a transmission of updated streaming service support messages S4 is performed in response to corresponding request messages S5′ received from the CDN CN 13a.

Upon the reception of the updated information from the MSF, the P2P-CDN may reconsider the streaming mode to be used for delivering the streaming content (of the ongoing session) to the UE 10a. Coming to a decision that the UE 10a should not be served with CDN mode any more, the CDN CN 13a may initiate a process with the P2P tracker 14a to initiate a corresponding streaming mode switching with respect to the UE 10a.

Thereto, CDN CN 13a sends switch request message S6 to the P2P tracker to request a P2P streaming mode with respect to UE 10a. The message may include at least one of UE ID, URL or streaming content ID/description, mobile UE info.

Based on the info included in switch request message S6 from the CDN CN, the P2P tracker determines a peer list and sends corresponding switch response S7 as discussed above.

As discussed under FIG. 4a, the CDN CN 13a sends DNS response S28 to the UE to request the UE to switch to P2P mode for the ongoing streaming service.

In response to DNS response S28 the UE switches to P2P streaming mode and initiates P2P sessions with peers of the peer list to enjoy the streaming service.

Above-described embodiments allows for providing flexible and user friendly hybrid CDN-P2P network services within the scope of current 3GPP standards.

1-20. (canceled)

21. A method for supporting a data stream provision towards a mobile user equipment (UE) within a communications network; the communications network comprising a mobile network and a data content network; wherein the data content network comprises a streaming control system for initiating the data streaming either from a content server having stored a corresponding data stream content, or from another UE (peer UE) having stored the data stream content; wherein the mobile network comprises a streaming support node for supporting the streaming control system, the method comprising:
the streaming support node acquiring information related to at least one of: a status and/or a capability of the mobile network serving the UE and a status and/or a capability of the UE to be served;
the streaming support node generating streaming support information based on the acquired information, for supporting the streaming control system in deciding whether to provide the streaming from the content server or from the peer UE;
the streaming support node providing the streaming support information to a node of the streaming control system.

22. The method of claim 21, wherein the streaming support information is provided in response to a reception of a request to provide the streaming support to the streaming control system.

23. The method of claim 21, wherein the streaming support information comprises streaming policy information.

24. The method of claim 21, further comprising updating the streaming support information in response to detecting a change of a status and/or a capability of at least one of the UE and the mobile network.

25. The method of claim 21, further comprising updating the streaming support information in response to a request from the streaming control system.

26. The method of claim 21, wherein the acquiring information related to the mobile network comprises acquiring information indicative of at least one of:
a radio cell load status in downlink (DL) direction;
a radio cell load status in uplink (UL) direction;
an available DL guaranteed bit rate;
an available UL guaranteed bit rate; and
a non-guaranteed bit rate derived from remaining air interface capacity.

27. The method of claim 21, wherein the acquiring information related to the UE comprises acquiring information indicative of at least one of:
a preference for streaming reception from the content server or from the peer UE;
a status and/or a capability of the UE power supply;
a location UE with respect to base stations of a radio access network;
an indication of a speed;
radio access technology capabilities;
radio access technology usage.

28. The method of claim 21, wherein the streaming support information is indicative of a preference or a request for one of:
a content server streaming mode comprising data streaming from the content server to the UE; and
a peer-to-peer streaming mode comprising data streaming from a peer UE to the UE.

29. The method of claim 28, wherein, upon reception of the streaming support information, the streaming control system decides, based on the streaming support information, which streaming mode comprising the content server streaming mode and the peer-to-peer streaming mode is to be performed.

30. The method of claim 29:
wherein the information related to the UE is indicative of a speed of the UE;
wherein the information related to the UE is used such that it is determined if the UE moves at a speed above a certain speed level;
wherein in response to determining that the UE moves at a speed above the certain speed lever, content server streaming is preferred over peer-to-peer streaming.

31. The method of claim 29, wherein the streaming control system:
decides whether, in response to an actually received streaming support information, a streaming mode shall be switched from server streaming mode to peer-to-peer streaming mode and vice versa;
transmits indication information to the UE comprising information indicative of an instruction to switch the streaming mode.

32. The method of claim 31, wherein, in response to the UE having sent a peer-to-peer streaming request, and an actually received streaming support information comprising a preference or a request to perform a content streaming, the streaming control system:
initiates a content server streaming;
transmits an indication information to the UE comprising an information indicative of an instruction to switch to an appropriate content server.

33. The method of claim 32, further comprising a gateway node detecting that the UE has sent a peer-to-peer streaming request, and in response to the detection initiates generating and transmitting the streaming support information from the streaming support node to the streaming control system.

34. The method of claim 31, wherein, in response to the UE having an ongoing streaming session by means of a peer-to-peer streaming, and a newly received streaming support information comprising a preference or a request to perform a content streaming, the streaming control system:
initiates a switching from peer-to-peer streaming to content server streaming for the streaming session;
transmits a switch indication information to the UE comprising an information indicative of a network address of an appropriate content server to be contacted.

35. The method of claim 31, wherein, in response to the UE having sent a content server streaming request, and upon reception of the streaming support information comprising a preference or a request to perform a peer-to-peer streaming, the streaming control system:
initiates a peer-to-peer streaming for the request;
transmits indication information to the UE comprising an information indicative of one or a plurality of peer UEs to be contacted.

36. The method of claim 31, wherein, in response to the UE having an ongoing streaming session by means of a content server streaming, and a newly received streaming support information comprising a preference or a request to perform a peer-to-peer streaming, the streaming control system:
initiates a switching from content server streaming to peer-to-peer streaming for the streaming session;
transmits switch indication information to the UE comprising an information indicative of one or a plurality of peer UEs to be contacted.

37. A streaming support node operable in a communications network comprising a mobile network and a data content network; wherein the data content network comprises a streaming control system for initiating the data streaming either from a content server having stored a corresponding data stream content or from another UE (peer UE) having stored the data stream content; the streaming support node comprising:
a first interface configured to communicate with a gateway node of the mobile network to receive information related to at least one of: a status and/or a capability of the mobile network serving the UE and a status and/or a capability of the UE to be served;
processing circuitry configured to generate streaming support information based on the acquired information, for supporting the streaming control system in deciding whether to provide the streaming from the content server or from the peer UE;
a second interface configured to communicate with the data content network to provide the streaming support information to the streaming control system.

38. The streaming support node of claim 37, further comprising a Policy and Charging Rules Function (PCRF) according to 3GPP.

39. A computer program product stored in a non-transitory computer readable medium for supporting a data stream provision towards a mobile user equipment (UE) within a communications network; the communications network comprising a mobile network and a data content network; wherein the data content network comprises a streaming control system for initiating the data streaming either from a content server having stored a corresponding data stream content, or from another UE (peer UE) having stored the data stream content; wherein the mobile network comprises a streaming support node for supporting the streaming control system, the computer program product comprising software instructions which, when run on one or more processors, causes the streaming support node to:
acquire information related to at least one of: a status and/or a capability of the mobile network serving the UE and a status and/or a capability of the UE to be served;
generate streaming support information based on the acquired information, for supporting the streaming control system in deciding whether to provide the streaming from the content server or from the peer UE;
provide the streaming support information to a node of the streaming control system.

40. A streaming control system operable in a communications network comprising a mobile network and a data content network, the streaming control system for initiating a data streaming either from a content server having stored a corresponding data stream content or from a peer UE having stored the data stream content, the streaming support node comprising:
a streaming control system interface configured to receive streaming support information from the mobile network;
a streaming control system processing circuitry configured to process the streaming support information to decide whether to provide the streaming from the content server or from the peer UE based on the streaming support information.
